(19) United States
(12) Patent Application Publication
(10) Pub. No.: US 2023/0091883 A1
(43) Pub. Date: Mar. 23, 2023

(54) INFRASTRUCTURE INSPECTION OPERATION BY USING MULTIPLE DRONES

(71) Applicant: HyDaaS Inc., Englewood, NJ (US)

(72) Inventor: Steven KIM, Englewood, NJ (US)

(21) Appl. No.: 17/945,954

(22) Filed: Sep. 15, 2022

Related U.S. Application Data
(60) Provisional application No. 63/245,417, filed on Sep. 17, 2021.

(51) Int. Cl. B64C 39/02; B64D 47/08

(52) U.S. Cl. CPC B64C 39/024; B64D 47/08; B64C 2201/123; B64C 2201/141

(57) ABSTRACT

A mobile drone communication and control system comprises a mobile drone station configured to be driven to a work area; a scanning drone carried by the mobile station and configured to scan an image of the work area and transmit the scanned image to the mobile station via a private WIFI network; an edge computer configured to analyze the scanned images and select the failure suspect points with an exact position identified coordinates; an inspection drone configured to fly out to the identified points and to perform a detailed inspection and equipped with a high pressure water or an air jet cleaner to clean the suspect points for detailed images; and a remote pilot center configured to program the routing plans of the scanning drone, the inspection drone and the mobile drone station.

### CROSS-REFERENCE TO RELATED APPLICATION

This application claims priority to U.S. Provisional Patent Application No. 63/245,417, filed on Sep. 17, 2021, which is hereby incorporated by reference in its entirety.

### BACKGROUND

### Field of the Disclosure

The present disclosure relates to an infrastructure inspection operation by using multiple drones.

### Description of the Background

A drone is rapidly utilized in a various industrial application such as filming & photography, inspection & maintenance, precision agriculture, mapping & surveying, surveillance & monitoring etc. Especially for the inspection & maintenance application, the drone provides a faster and more efficient service than the inspection by human beings.

A licensed human operator on site is often required when the drone is used in inspection and maintenance. However, the skill for inspection is a different set of skill from the operation skill of the drone.

A fast moving drone with a full speed of 40 km per hour often transmits the image of the inspection objects such as solar cell panels. Thus, it is very difficult to determine whether the panel is damaged or is requiring a service for a drone operator while operating the drone.

### SUMMARY

Accordingly, the present disclosure is directed to an infrastructure inspection operation by using multiple drones that substantially obviates one or more of problems due to limitations and disadvantages of the prior art.

More specifically, the present disclosure is to provide a mobile drone communication and control system that a remote pilot center is managing and configuring a mobile drone station, multiple number of the task drones, and the data obtained by the drones.

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and in accordance with the present disclosure, as embodied and broadly described, a mobile drone communication and control system comprises a remote pilot center (300) communicating with the mobile drone station (100); and a mobile drone station configured to be driven to a work area (400); a scanning drone (201) carried by the mobile drone station (100) and configured to scan an image of the work area and transmit the scanned images to the mobile station via a private WIFI network (102); an edge computer (104) configured to analyze the scanned images and select the failure suspect points (402) with an exact position identified position coordinates; an inspection drone (202) configured to fly out to the identified failure suspect points (402) and to perform a detailed inspection and equipped with a high pressure water or an air jet cleaner (203) to clean the suspect failure points for the detailed images.

The detail images are sent to the mobile drone station (100) and forwarded to the remote pilot center (300) to be reviewed by a human expert.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure. This patent or application file contains at least one drawing executed in color. Copies of this patent or patent application publication with color drawings will be provided by the U.S. Patent and Trademark Office upon request and payment of the necessary fee.

In the drawings:

FIG. 1 is a representation of the mobile drone communication and control system for the infrastructure inspection using a mobile drone station (100) carrying the multiple task drones (201), (202) according to the present disclosure; and

FIG. 2 is a view showing the example working area of the infrastructure inspection site that the scanning drone (201) is scanning the working area (400) and the inspection drone (202) is doing a detailed inspection task for the identified failure suspect points.

### DETAILED DESCRIPTION

Reference will now be made in detail to the aspects of the present disclosure, examples of which are illustrated in the accompanying drawings. Wherever possible, the same reference numbers will be used throughout the drawings to refer to the same or like parts.

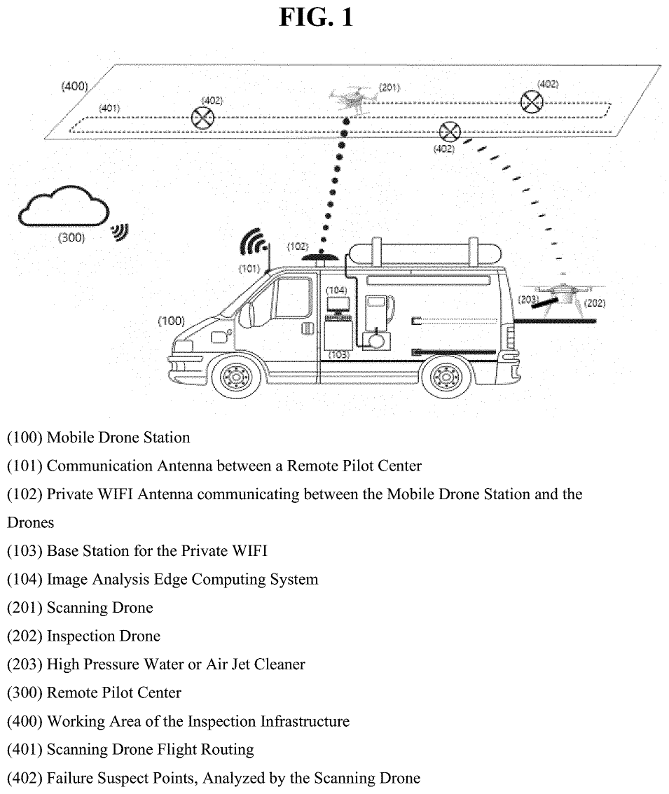

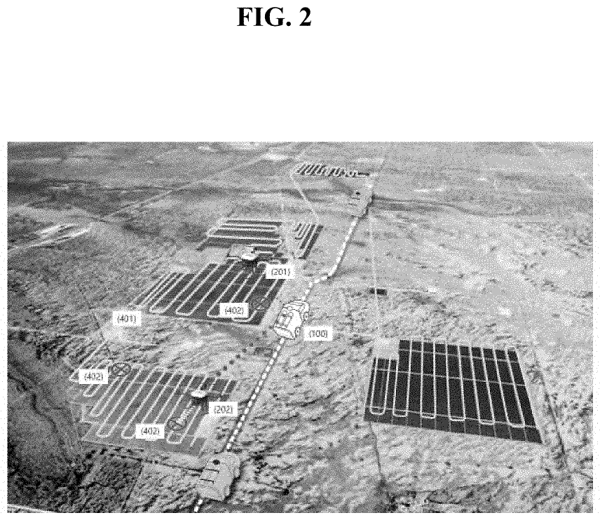

In order to achieve the highly efficient inspection, the mobile drone station works with multiple drones, a scanning drone (201) and an inspection drone (202) with a support of the image analysis edge computer system (104) as shown in FIGS. 1 and 2.

The role for the remote pilot center (300) is configuring a drone flight reservation permission process; providing a drone identification number, drone flight routing (401) and time information to the local drone traffic management authority as well as is configuring a routing plan of the mobile drone station (100) according the drone flight routing plan. The scanning drone (201) is scanning the work area (400) following the route (401) as programmed by the remote pilot center (300). The scanning drone sends the image of the work area to the mobile drone station (100) via a private WIFI (102). The scanned images will then be analyzed by using the edge computer (104) and then identify the failure suspect points (402).

The inspect drone (202) is flying over the identified failure suspect points and is taking the detailed photos of the failure suspect points (402). In case, a simple cleaning is necessary, the built in high pressure water or air jet cleaner (203) is cleaning the suspect point for the detailed images of the failure suspect points (402). The detailed image is then transmitted to the mobile drone station (100) via a private WIFI (102) and it is then forwarded to the remote pilot center (300) via a commercial wireless network (101) for a human expert review at the remote pilot center.

It will be apparent to those skilled in the art that various modifications and variations can be made in the mobile drone communication and control system of the present disclosure without departing from the spirit or scope of the aspects. Thus, it is intended that the present disclosure covers the modifications and variations of the aspects provided they come within the scope of the appended claims and their equivalents.

What is claimed is:

1. A mobile drone communication and control system, comprising:
a mobile station configured to be driven to a work area;
a scanning drone carried by the mobile station and configured to scan images of the work area and transmit the scanned images to the mobile station via a private WIFI network;
an edge computer configured to analyze the scanned images and identify the failure suspect points with an exact position identified coordinates;
an inspection drone configured to fly out to the identified failed suspect points and to perform a detailed inspection and is equipped with a high pressure water or an air jet cleaner to clean the failure suspect points for the detailed images; and
a remote pilot center configured to program the routing plans for the scanning drone, the inspection drone and the mobile drone station.

2. The mobile drone communication and control system of claim 1, wherein the detailed images taken from the inspection drone, are sent to the mobile drone station and then forwarded to the remote pilot center to be reviewed by a human expert.
